(19) United States
(12) Patent Application Publication
(10) Pub. No.: US 2013/0158749 A1
(43) Pub. Date: Jun. 20, 2013

(54) METHODS, SYSTEMS, AND APPARATUSES FOR MEASURING FLUID VELOCITY

(71) Applicant: Aaron Contorer, Encinitas, CA (US)

(72) Inventor: Aaron Contorer, Encinitas, CA (US)

(21) Appl. No.: 13/325,835

(22) Filed: Dec. 14, 2011

(51) Int. Cl. G05D 1/00; G06F 19/00; G01M 17/00

(52) U.S. Cl. 701/3; 701/1; 701/21; 701/33.1; 702/45

(57) ABSTRACT

Methods, systems, and apparatuses are disclosed for a measuring the velocity of a fluid.

### BACKGROUND

The measurement of fluid velocities, particularly, wind velocity and water current velocity, is very important for many applications. For example, knowing wind velocity in a particular area can be advantageous, if not critical, for air travel, meteorological studies, structural engineering, identification of viable locations for harvesting wind energy, and safety of individuals in the wake of a disaster (e.g., estimating areas that will be impacted by smoke and ash from a volcano eruption). Similarly, knowing water current velocities is useful in sea travel, fishing activities, water turbine placement, and as above, protecting individuals in the wake of a disaster (e.g., an oil spill).

Existing technologies used to measure fluid velocity include RADAR, LIDAR, which use measure the movement of air (or raindrops or other particulate in the air) by reflecting energy at a distance. However, these technologies fall victim to being blocked by intervening weather systems, and are typically cost-prohibitive. Additionally, fluid velocities can be measured by weather sensors, such as radiosondes, which are often deployed on balloons or parachutes to be caught in currents. However, such devices are at the mercy of the currents and move along with them away from a target area. Finally, aircraft and boats can be used to calculate fluid velocities by measuring apparent wind (across sensors located on these vehicles) and vehicle groundspeed, and combining the two arithmetically. This method relies upon wind speed sensors (typically, pitot tubes), which are subject to inaccurate readings due to weather and ice, and which do not perform properly locally in very turbulent conditions.

What are needed are methods, systems, and apparatuses for measuring fluid velocities across a range of locations, without the need for expensive special-purpose hardware, and with accuracy previously unachieved.

### SUMMARY

In one embodiment, an apparatus for measuring a fluid velocity is provided, the apparatus comprising: a vehicle; a location sensor configured to identify a location of the vehicle at two or more points in the fluid; and a controller configured to control a movement of the vehicle in the fluid, wherein the controller is configured to calculate a vector using the two or more points in the fluid.

In another embodiment, a method for measuring a fluid velocity is provided, the method comprising: placing a vehicle in a fluid; identifying a first location of the vehicle in the fluid at a first time using the location sensor; causing the vehicle to travel in the fluid along a predetermined course having a predicted end location using a controller; identifying a second location of the vehicle in the fluid at a second time using the location sensor; and calculating the fluid velocity by comparing the second location with the predicted end location.

In another embodiment, an apparatus for measuring a fluid velocity is provided, the apparatus comprising: a vehicle traveling in a fluid measurement zone of a fluid medium; a location sensor configured to identify a first location at a first time and a second location at a second time for two or more headings; a controller configured to cause the vehicle to travel in the fluid measurement zone at two or more headings, wherein the sum of the two or more headings is equal to zero; a velocity vector defined by the first location of the vehicle at a first time, and the second location of the vehicle at a second time for each of the two or more headings; and a fluid velocity vector defined by the addition of the velocity vector for each of the two or more headings.

In another embodiment, a method for measuring a fluid velocity is provided, the method comprising: placing a vehicle in a fluid, wherein the vehicle is hover-capable; identifying a first location of the vehicle in the fluid at a first time using a location sensor; identifying a second location of the vehicle in the fluid at a second time using the location sensor; and calculating the fluid velocity by comparing the first location with the second location.

In another embodiment, a method for calibrating a vehicle's controller is provided, the method comprising: placing a vehicle in a fluid; identifying a first location of the vehicle in the fluid at a first time using a location sensor; causing the vehicle to travel in the fluid along a predetermined course having a predicted end location and a theoretical vector using the controller; identifying a second location of the vehicle in the fluid at a second time using a location sensor and calculating an observed vector; comparing the observed vector and the theoretical vector to identify any discrepancy between the observed vector and the theoretical vector; and calibrating the controller and the vehicle's control surfaces so that the observed vector is the same as the theoretical vector.

### BRIEF DESCRIPTION OF THE DRAWINGS

The accompanying figures, which are incorporated in and constitute a part of the specification, illustrate various example systems, methods, and results, and are used merely to illustrate various example embodiments.

FIG. 1 illustrates an example arrangement of an apparatus for measuring fluid velocity.

FIG. 2 illustrates an example method for measuring fluid velocity.

FIG. 3 illustrates another example method for measuring fluid velocity.

FIG. 4 illustrates another example arrangement of an apparatus for measuring fluid velocity.

FIG. 5 illustrates another example method for measuring fluid velocity.

### DETAILED DESCRIPTION

It should be noted that the term “velocity” is intended to represent its commonly accepted physics definition, that is, the measurement of the rate and direction of change in the location of an object. Additionally, it should be noted that the example embodiments of the invention are intended to be equally applicable to measuring the velocity of any fluid medium, regardless of whether the fluid medium identified in the example embodiment is “air” or “water.” Finally, it should be noted that in some instances the recited resultant of calculations is referred to as a “vector.” The recited vector in each of the methods herein described is intended to represent a “velocity vector,” and as such, may be used interchangeably with “velocity.”

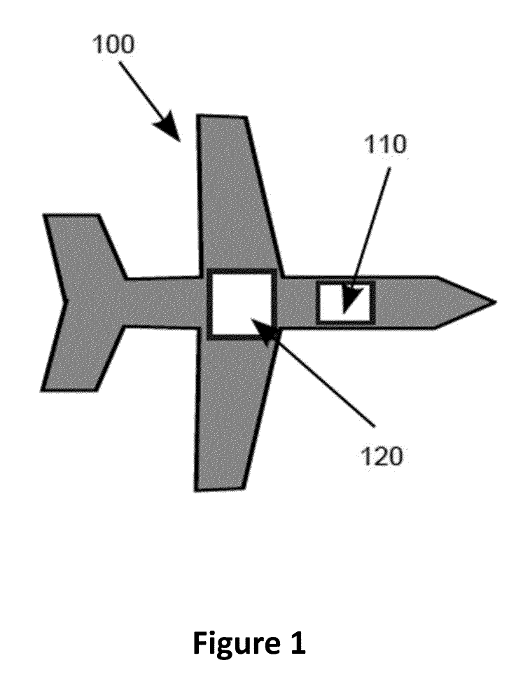

FIG. 1 illustrates one embodiment of an example arrangement of an apparatus for measuring fluid velocity. Vehicle 100 includes a controller 110 and a location sensor 120. In one embodiment, controller 110 and location sensor 120 are carried onboard vehicle 100. In another embodiment, at least one of controller 110 and location sensor 120 are located offboard vehicle 100 at a remote location. In another embodiment, controller 110 includes multiple components, and one or more component is located onboard vehicle 100 while one or more component is located offboard vehicle 100 at a remote location. In still another embodiment, location sensor 120 includes multiple components, and one or more component is located onboard vehicle 100 while one or more component is located offboard vehicle 100 at a remote location.

In one embodiment, vehicle 100 is an airborne vehicle, such as an airplane, helicopter, or any other flying vehicle capable of controlled flight. In such an embodiment, vehicle 100 may be configured to measure wind velocity in an air medium. In another embodiment, vehicle 100 is a waterborne vehicle, such as a boat, submarine, or any other vehicle capable of controlled movement in a water medium. In such an embodiment, vehicle 100 may be configured to measure water current velocity in a water medium, including without limitation, rivers, lakes, reservoirs, oceans, and holding tanks.

In one embodiment, vehicle 100 is unmanned. Vehicle 100 may be remote controlled by a human operator in a remote location. Any of various known means of remotely controlling a vehicle are contemplated in this embodiment. In another embodiment, vehicle 100 is autonomous, and configured to operate independent of a human operator for a substantial period of time. In this embodiment, controller 110 may be configured to guide vehicle 100 indefinitely. Alternatively, software may be uploaded to controller 110 allowing vehicle 100 to operate independently until the conclusion of the uploaded flight plan, at which point vehicle 100 may return to its base of operation. In yet another embodiment, vehicle 100 is a manned vehicle controlled by a human operator onboard vehicle 100.

Controller 110 may comprise a computer having software, an electronic device, or an electromechanical device. In one embodiment, controller 110 is configured to control a movement of vehicle 100 in the fluid medium. In another embodiment, controller 110 is configured to operate vehicle 100 in accordance with a software program contained therein. Controller 110 may be configured to adapt to conditions encountered during testing and perform additional tests or repeated tests upon a predetermined triggering event (e.g., upon calculation of test results that are outside a predetermined range of values, upon interference by some external force that jeopardizes the test results, or upon an error alert generated by one or more components of vehicle 100). In one embodiment, controller 110 is configured to calibrate and correct itself during vehicle 100's deployment. Controller 110 may be operatively connected to the control surfaces of vehicle 100, and capable of directing the movement of vehicle 100 through a fluid medium. Controller 110 may be capable of monitoring and maintaining a desired heading through adjustment of vehicle 100's control surfaces and propulsion system. Controller 110 may be capable and monitoring and maintaining a desired direction of vehicle 100, for example, east. In one embodiment, controller 110 may be operatively connected to the propulsion system of vehicle 100, and capable of adjusting the thrust of the propulsion system as necessary to perform tests and/or travel between test areas (e.g., control of engine speed, propeller blade pitch, etc.).

In one embodiment, controller 110 includes a processing unit configured to record data. The processing unit may be further configured to analyze data and generate fluid velocity measurements. In one embodiment, controller 110 is configured to calculate a vector using two or more points in a fluid medium. In another embodiment, controller 110 may collect data relating to at least one of position, time, velocity, temperature, pressure, altitude, date, and weather conditions.

In one embodiment, controller 110 is configured to alternate between flight controlled relative to a fixed point (e.g., relative to a point on earth) and control surface-based flight (e.g., relative to the fluid medium). Controller 110 may use location discrepancies observed after control surface-based flight to calculate the net effects of fluid flow, such as wind.

Controller 110 may utilize a guidance system using GPS, LORAN, a triangulation system (onboard vehicle 100 or offboard at a remote location), RADAR, and LIDAR. In one embodiment, controller 110 is configured to alternate between guidance system-based flight and measurement (e.g., measured relative to the earth) and control surface-based non-guidance system-based flight (e.g., relative to the wind). Controller 110 may use location discrepancies observed after non-guidance system-based flight segments to calculate the net effects of fluid flow, such as wind.

In one embodiment, location sensor 120 is configured to selectively identify vehicle 100's location. In another embodiment, location sensor 120 is configured to continuously identify vehicle 100's location. In another embodiment, location sensor 120 is configured to identify the location of vehicle 100 at two or more points in the fluid medium. In one embodiment, location sensor 120 is operatively connected to controller 110. Location sensor 120 may measure vehicle 100's location relative to a fixed point. In one embodiment, location sensor 120 is configured to identify vehicle 100's location in a three-dimensional parcel of the fluid medium, for example, by identifying three axes of reference, including longitude, latitude, and elevation data. In another embodiment, location sensor 120 is configured to identify vehicle 100's location in a two dimensional parcel of the fluid medium, for example, by identifying two points of reference, such as longitude and latitude. In one embodiment, location sensor 120 is configured to record data relating to vehicle 100's location and store it for a desired period of time.

Location sensor 120 may be one or more of GPS, LORAN, a triangulation system (onboard vehicle 100 or offboard at a remote location), RADAR, and LIDAR. In one embodiment, location sensor 120 may be any device capable of measuring the location of vehicle 100 relative to a fixed point. In another embodiment, location sensor 120 is any system capable of determining the location of vehicle 100 relative to the earth's surface with reasonable precision. As previously discussed, location sensor 120 may be located onboard vehicle 100, offboard vehicle 100 at a remote a location, or a combination of onboard and offboard vehicle 100.

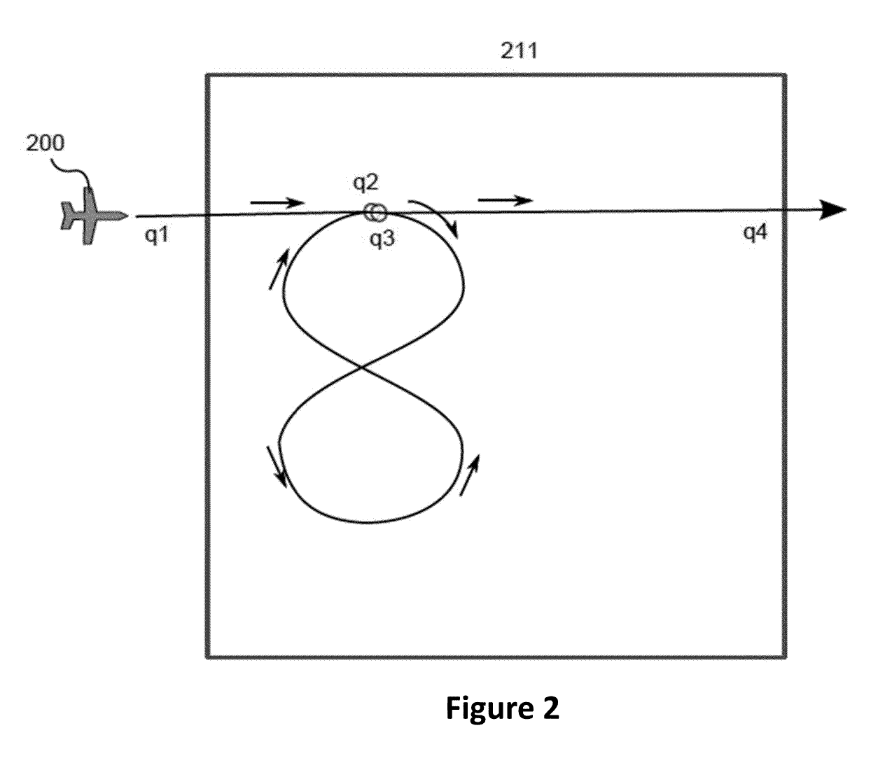

FIG. 2 illustrates an example method for measuring fluid velocity, including a vehicle 200, and a fluid measurement zone 211. Vehicle 200 includes a controller (not shown) and a location sensor (not shown). A series of locations, q1, q2, q3, and q4 are illustrated, along with a predetermined course in the shape of a figure-eight. In one embodiment, vehicle 200 enters fluid measurement zone 211 at location q1. At location q2, vehicle 200's location is identified using a location sensor. Following completion of the predetermined figure-eight course, vehicle 200's location is identified using a location sensor (location q3). Finally, vehicle 200 exits fluid measurement zone 211 at location q4. Vehicle 200 may be any vehicle as described above with reference to FIG. 1. Alternatively, the predetermined course may include any closed course. A closed course includes a course, which, in a nonmoving medium would result in the vehicle returning to its starting point, including a figure-eight or a loop.

Fluid measurement zone 211 may be any plane, slice, surface, or volume of fluid in which one desires to calculate fluid velocities. In one embodiment, fluid measurement zone 211 is a three-dimensional section of air above the earth's surface, and vehicle 200 is used to measure wind velocity within fluid measurement zone 211. In another embodiment, fluid measurement zone 211 is a three-dimensional section of water, and vehicle 200 is configured to measure water current velocity within fluid measurement zone 211. Additionally, fluid measurement zone 211 may be a two-dimensional section of fluid, for example, on the surface of a body of water, on a plane within air above the earth, or on a subsurface plane within a body of water on the earth's surface. In another embodiment, fluid measurement zone 211 may be any section of any fluid in which vehicle 200 can maneuver and in which one desires to calculate fluid velocities.

In one embodiment, vehicle 200 is placed within a fluid and guided to fluid measurement zone 211. Vehicle 200 identifies its location q2 (a first location) using a location sensor at a first time. Next, vehicle 200 is directed to travel along a predetermined closed course, the starting location of which is q2, such as the figure-eight course illustrated in FIG. 2. Vehicle 200 travels the closed course at the guidance of the controller until it reaches what the controller believes is the predicted end location. Upon completing the closed course, vehicle 200 again identifies its location q3 (a second location) using a location sensor at a second time. In one embodiment, the controller tracks the amount of time vehicle 200 took to travel from first location q2, a first time, to second location q3, a second time, (the elapsed time between first time and second time being the actual time). The fluid velocity may be calculated by comparing the second location q3 with the predicted end location. Stated another way, we first identify the observed velocity vector (the vector between q2 and q3, which is representative of the actual course taken by vehicle 200). Observed velocity vector is obtained by (q3−q2)/(time 2−time 1). We compare the observed velocity vector to the known velocity vector (the vector between q2 and the predicted end location of the predetermined closed course, which is representative of the course taken by vehicle 200 in a nonmoving fluid medium). The fluid velocity=(observed velocity vector)−(known velocity vector).

In one embodiment, in a zero fluid velocity scenario, the predetermined course is configured such that the predicted end location and the actual end location q3 are identical. In another embodiment, in a zero fluid velocity scenario, the predetermined course is configured such that the predicted end location has a predicted offset from the actual end location q3, and this predicted offset is identical to the actual offset between predicted end location and actual end location q3. In another embodiment, the predetermined course includes a series of maneuvers and the sum of vectors generated from all of the maneuvers equals zero. In still another embodiment, the predetermined course includes a series of maneuvers and the sum of vectors generated from all of the maneuvers equals a predicted non-zero vector.

In one embodiment, vehicle 200 travels a predetermined course that is a figure-eight pattern. In another embodiment, vehicle 200 travels in any one or more of a circle, an oval, a figure-eight, a series of figure-eights, a series of circles, a series of ovals, a straight line, a series of straight lines, and any combination thereof. In another embodiment, vehicle 200 travels in any predetermined course having either a predicted end location that is the same as a first location in a zero fluid velocity environment, or having a predicted end location that has a predicted offset from a first location in a zero fluid velocity environment. In another embodiment, the predetermined course may include any closed course. A closed course includes a course, which, in a nonmoving medium would result in the vehicle returning to its starting point, including a figure-eight or a loop. Alternatively, the predetermined course may include a non-closed course, wherein in a nonmoving medium, the vehicle would not return to its starting point, as would be the cause in a straight line course. In another embodiment, vehicle 200 utilizes its controller to change the size and shape of the predetermined course so as to accommodate different sizes and shapes of fluid measurement zones. For example, a fluid measurement zone may include an obstruction, such as a tower, around which vehicle 200 must operate without colliding with the obstruction.

In one embodiment, vehicle 200 travels in a closed course, such as a circle, oval, figure-eight, or series of each. That is, in a zero fluid velocity environment, the starting point and ending point of the course would be the same point. Use of such a course may allow for cancelling of some or all of the error associated with the measurements collected by the location sensor, and/or the vehicle positioning as performed by the controller, because the vehicle spends and approximately equal portion of its maneuver time traveling in each direction. For example, perhaps the controller attempts to direct the vehicle to turn at a desired rate, but the vehicle is actually not calibrated and such a command to turn at a desired rate causes the vehicle to turn more rapidly than intended. In a figure-eight closed course, the vehicle will spend approximately the same amount of time attempting to turn a certain degree left at a desired rate as attempting to turn the same degree right at a desired rate. This results in the error caused by the vehicle's lack of calibration to be cancelled out, and the vehicle's predicted end point is still approximately equal to its starting point, regardless of this lack of calibration. Thus, the use of closed course maneuvers can yield more accurate results than non-closed course maneuvers.

In one embodiment, between locations q1 and q2, and between locations q3 and q4, vehicle 200 travels using GPS-guided flight. Such GPS-guided flight may rely upon communication of location from the location sensor to the controller, and is generally measured relative to a fixed point, such as the earth's surface. Further, the controller may make flight corrections based upon vehicle 200's location in reference to a fixed point. Between locations q2 and q3, vehicle 200 travels using non-GPS-guided flight. Such non-GPS-guided flight may rely exclusively upon guidance by the controller, without any positional reference to a fixed surface. That is, vehicle 200 flies strictly with reference to the fluid medium in which it travels, and does not make any flight corrections based upon its location relative to a fixed point.

In one embodiment, the controller compares the predicted end location with the actual end location q3, factoring in any predicted offset and accounting for the actual time, and calculates the fluid velocity. In another embodiment, an operator compares the predicted end location with the actual end location q3 to calculate the fluid velocity. In one embodiment, a vector is generated representing the predicted end location and the actual end location q3. Dividing the vector by the actual time reveals the direction and rate of fluid flow, which is the fluid velocity.

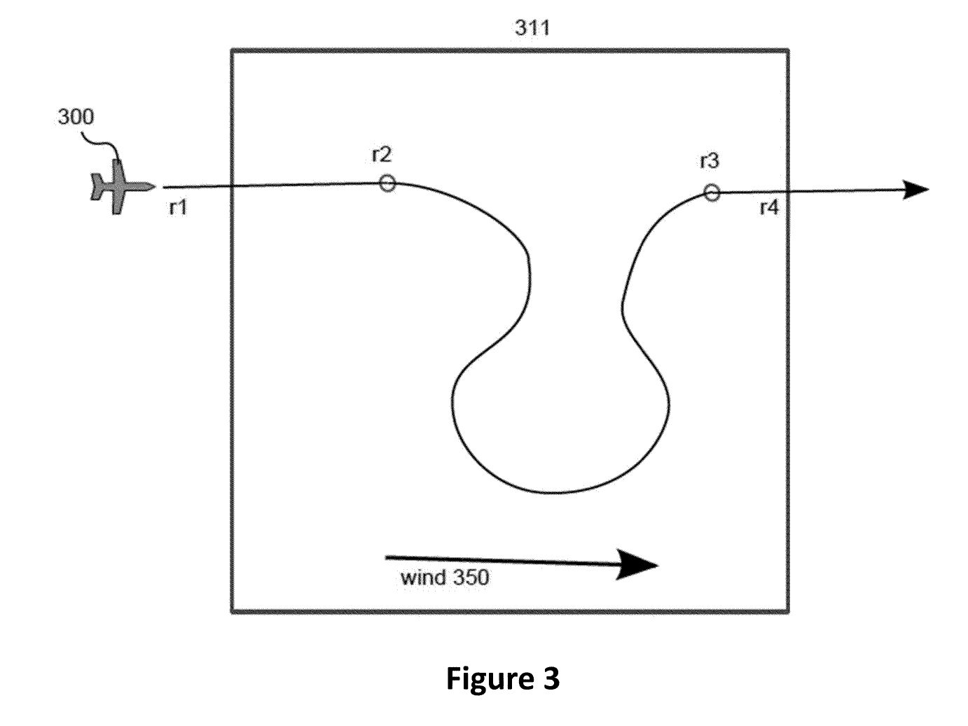

As illustrated in FIG. 2, first location q2 and second location q3 (representing the actual end location) are almost in the same location. Accordingly, the velocity of the fluid is nearly zero. However, as illustrated in FIG. 3, in a fluid medium having a velocity that is not nearly zero, second location r3 (representing the actual end location) is significantly displaced from first location r2.

FIG. 3 illustrates an embodiment wherein a vehicle 300 travels into a fluid measurement zone 311 at an entry location r1. Vehicle 300 includes a controller (not shown) and a location sensor (not shown). Upon vehicle 300's arrival at a first location r2, a location sensor identifies vehicle 300's location, which may be recorded by a controller. The controller then guides vehicle 300 through a figure-eight maneuver, wherein the maneuver is relative to the fluid medium, and not relative to a fixed point such as the earth's surface. However, as is illustrated in FIG. 3, the fluid medium (e.g., air) is moving at a non-zero velocity (e.g., wind), which causes vehicle 300's path when viewed relative to a fixed point, such as the earth's surface, to look nothing like a figure-eight. This is because while vehicle 300 is performing the maneuver, the fluid medium in which it is operating is moving from left to right. Upon vehicle 300's arrival at the end of the maneuver (which, due to fluid movement likely differs from what the controller calculates should be the end point if the fluid were not moving), the location sensor identifies vehicle 300's actual end location of the maneuver, represented by r3 (second location). In the example embodiment illustrated in FIG. 3, the maneuver was a figure-eight pattern, in which the predicted end location should have been substantially identical to the first location r2 in a zero fluid velocity scenario. In one embodiment, the controller calculates a vector representing the relationship between a predicted end location (that is, the location that vehicle 300 would have had in a zero-wind environment) and a second location r3, which is divided by the actual time vehicle 300 took to complete the maneuver, thus yielding the velocity of the fluid medium within fluid measurement zone 311. In another embodiment, where vehicle 300's predicted end location should be substantially equal to its start location (first location r2), such as in a figure-eight pattern, the controller calculates a vector representing the relationship between first location r2 and second location r3, which is divided by the actual time to yield the velocity of the fluid medium. The velocity of the fluid medium may be represented as a vector, such as vector 350.

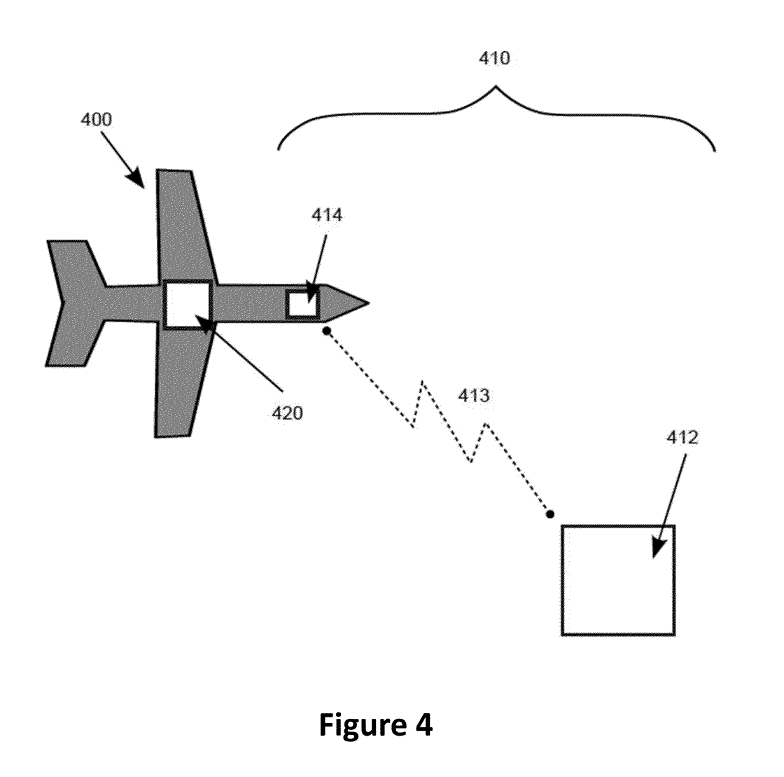

FIG. 4 illustrates another exemplary embodiment, wherein vehicle 400 includes a controller 410, which comprises an off-board computer 412 linked via radio communication 413 to an on-board receiver 414. Vehicle 400 additionally includes a location sensor 420.

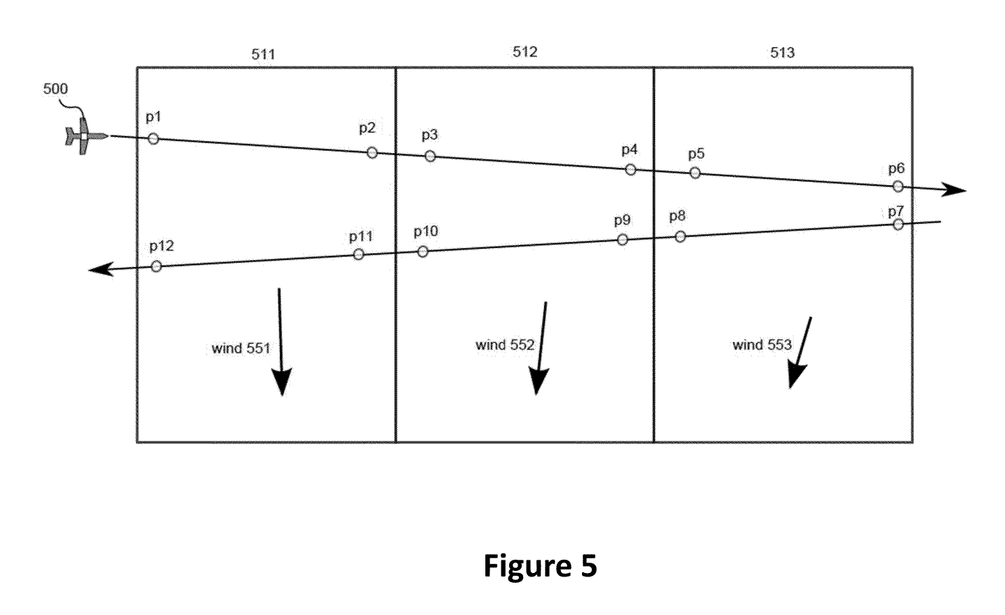

FIG. 5 illustrates another example method of calculating a fluid velocity over a series of fluid measurement zones. Vehicle 500 includes either onboard or offboard, a controller (not shown) and a location sensor (not shown). The controller directs vehicle 500 to the entry of the first fluid measurement zone 511, which may be adjacent to or overlapping with a second fluid measurement zone 512. Similarly, a third fluid measurement zone 513 may be adjacent to or overlapping with second fluid measurement zone 512. Note that any number of fluid measurement zones may be analyzed at one time in this example method. In one embodiment, fluid measurement zones 511, 512, and 513 may be aligned along a straight line and vehicle 500 maintains a constant heading at a constant thrust (e.g., a constant engine RPM) to travel through fluid measurement zones 511, 512, and 513.

The controller directs vehicle 500 to set its heading so as to pass through each of fluid measurement zones 511, 512, and 513 consecutively. Vehicle 500 enters first fluid measurement zone 511 and the location sensor identifies vehicle 500's first location p1 therein, at a first time (first direction, first location of vehicle 500). Vehicle 500 progresses through first fluid measurement zone 511, and the location sensor identifies vehicle 500's second location p2 therein, at a second time (first direction, second location of vehicle 500). Vehicle 500 proceeds to leave the first fluid measurement zone 511 and enter the second fluid measurement zone 512 along the same heading at which it passed through fluid measurement zone 511. Again, the location sensor identifies vehicle 500's first location p3 and second location p4 in second fluid measurement zone 512, at a first time and a second time, respectively. The process is repeated for third fluid measurement zone 513.

Using the first location, first time, second location, and second time in each fluid measurement zone, the controller calculates an observed vector (accounting for speed and direction) within each of fluid measurement zones 511, 512, and 513. That is, the controller identifies a first observed vector representing the relationship between first location p1 and second location p2 in first fluid measurement zone 511. The controller identifies a second observed vector representing the relationship between first location p3 and second location p4 in second fluid measurement zone 512. Finally, the controller identifies a third observed vector representing the relationship between first location p5 and second location p6 in third fluid measurement zone 513.

Also calculated is a predicted end location within each fluid measurement zone, based upon the difference between the first time and the second time (i.e., the elapsed time). The predicted end location represents the location of vehicle 500 in a fluid measurement zone if the fluid measurement zone had a zero fluid velocity, given the heading of vehicle 500 as it progressed through that fluid measurement zone, traveling for the elapsed time. For example, referring to first fluid measurement zone 511, using first location p1, the predicted end location calculated for first fluid measurement zone 511, and the elapsed time calculated for first fluid measurement zone 511, a first theoretical vector can be calculated representing the relationship between first location p1 and the predicted end location for first fluid measurement zone 511. In this manner, a second theoretical vector can be calculated for second fluid measurement zone 512, and a third theoretical vector can be calculated for a third fluid measurement zone 513.

If vehicle 500 is well-calibrated, that is, if vehicle 500 is capable of maintaining a substantially constant heading and a substantially constant thrust (e.g., constant engine RPM), a single pass through the series of fluid measurement zones may yield accurate wind vectors. In this embodiment, a wind vector for each fluid measurement zone is calculated by subtracting the observed vector in that fluid measurement zone from the theoretical vector in the fluid measurement zone. For example, subtracting first theoretical vector from first observed vector yields a first fluid velocity vector 551 for first fluid measurement zone 511. Similarly, second fluid velocity vector 552 is calculated for second fluid measurement zone 512, and third fluid velocity vector 553 is calculated for third fluid measurement zone 513.

Using the various locations illustrated in FIG. 5 for a single pass, one can calculate each of the vectors described above using well known methods of vector addition and subtraction. For example, to calculate wind vector 551 in first fluid measurement zone 511, one may subtract first location p1 from second location p2, yielding the first observed vector, which represents the path vehicle 500 actually followed through first fluid measurement zone 511, and the actual location vehicle 500 had at second location p2. One may subtract the time recorded at p1 from the time recorded at p2, thus representing the elapsed time. One may also subtract first location p1 from the predicted end location, yielding the first theoretical vector, which represents the path vehicle 500 would have followed in a zero fluid velocity scenario, and the location vehicle 500 would have been in after the elapsed time recorded between locations p1 and p2. Subtracting the first theoretical vector from the first observed vector yields first fluid velocity vector 551.

In one embodiment, vehicle 500 is not well-calibrated, and is not capable of maintaining a substantially constant heading and a substantially constant thrust. In this embodiment, a second pass through the fluid measurement zones may be necessary. In order to cancel any errors experienced due to vehicle 500's inability to maintain a substantially constant heading and a substantially constant thrust, vehicle 500 executes a second pass at an opposite heading from that utilized in the first pass. As such, vehicle 500 passes first into third fluid measurement zone 513 and records a first location p7 (second direction first location of vehicle 500) and a second location p8 (second direction second location of vehicle 500). Next vehicle 500 passes through second fluid measurement zone 512 and records a first location p9 and a second location p10. Finally, vehicle 500 passes through first fluid measurement zone 511 and records a first location p11 and a second location p12. As described above, a theoretical vector and an observed vector is calculated for each of fluid measurement zones 511, 512, and 513. Using the theoretical vectors and observed vectors from each of the two passes, wind vectors 551, 552, and 553 are calculated.

In another embodiment, more or less than two passes can be made through a series of fluid measurement zones, regardless of vehicle calibration. In one embodiment, more than two passes can be made through one or more fluid measurement zones, wherein the sum of the headings is equal to zero. For example, three passes may be made through a measurement zone, wherein the headings of each of the three passes are 120 degrees from the others, resulting in a heading sum of zero. As another example, four passes may be made through ha measurement zone, wherein the headings of each of the four passes are 90 degrees from the others, resulting in a heading sum of zero.

Using the various locations illustrated in FIG. 5 for two passes, one can calculate each of the vectors described above. For example, to calculate wind vector 551 in first fluid measurement zone 511, one may subtract first location p1 from second location p2, yielding the first pass first observed vector, which represents the path vehicle 500 actually followed through first fluid measurement zone 511 during the first pass, and the actual location vehicle 500 had at second location p2. Similarly, subtracting first location p11 from second location p12 yields the second pass first observed vector, which represents the path vehicle 500 actually followed through first fluid measurement zone 511 during the second pass and the actual location vehicle 500 had at second location p12. Adding these two differences, that is, adding the first pass first observed vector to the second pass first observed vector yields wind vector 551. Note that calculating a first pass first theoretical vector and a second pass first theoretical vector in this embodiment is unnecessary, as the first pass first theoretical vector and second pass first theoretical vector should be substantially opposite one another. As such, when the theoretical vectors are added, they should sum approximately zero (this is analogous to the fact that adding 5 and (−5)=0). Note that this “two pass” embodiment may require some approximation, since fluid flow, such as wind, may make the second pass course not perfectly align with the first pass course. That is, while the two passes can have exactly opposite settings, the first pass may be offset from the second pass by some distance due to wind pushing vehicle 500 off course during and between the two passes. Accordingly, the first theoretical vector and second theoretical vector may not literally be exactly opposite, should they be calculated. However, approximating that the two are exactly opposite introduces very little error in most applications.

In one embodiment, the location sensor identifies, and the controller records, at least two locations in each of the fluid measurement zones 511, 512, and 513. In another embodiment, the location sensor identifies, and the controller records, more than two locations in each of the fluid measurement zones 511, 512, and 513.

In one embodiment, a single vehicle 500 is capable of measuring fluid velocities over numerous fluid measurement zones spanning great distances. In one embodiment, a plurality of vehicles may be operatively connected in a network to measure fluid velocities in a network of fluid measurement zones.

In one exemplary embodiment, the vehicle is an aircraft and the fluid is air above the earth's surface. The location sensor is a GPS, and the controller includes GPS navigation. The methods includes the following steps: (1) fly the aircraft to a target spot using GPS-guided flight; (2) set engine speed to 8,000 RPM; (3) use the GPS compass and aircraft control surfaces to turn the aircraft's heading to 0 degrees (North); (4) level aircraft, setting rudder and all control surfaces to neutral (centered) and disable GPS-guided flight; (5) measure exact location “A” on GPS location sensor; (6) fly for t=10 seconds; (7) measure exact location “B” on GPS location sensor; (8) set aircraft for turn (hard right rudder and soft right ailerons); (9) use GPS compass and aircraft control surfaces to turn aircraft's heading to 180 degrees (South); level aircraft, setting rudder and all control surfaces to neutral (centered); (10) measure exact location “C” on GPS location sensor; (11) fly for t=10 seconds; (12) measure exact location “D” on GPS location sensor; (13) calculate wind velocity vector; and (14) resume GPS-guided flight to next waypoint or destination. The wind velocity vector=(B+D−C−A)/2 t. This calculation effectively causes the northbound flight and southbound flight to cancel one another out, thus leaving only the wind-induced motion, and thus the wind velocity vector.

In one embodiment, the vehicle is hover-capable, such as a helicopter or submarine. The vehicle is caused to hover in a fluid stream, such that the velocity of the vehicle substantially matches the velocity of the fluid stream. In this embodiment, the vehicle records a first location via a location sensor, and hovers for a period of time t. After the lapse of t seconds, the vehicle turns 180 degrees in place and hovers again for a period of time t, at which point the vehicle records a second location. The subtracting the first location from the second location, and dividing by 2 t yields the fluid velocity vector. Causing the vehicle to hover facing one direction, and then turn 180 degrees and hover facing the other direction acts to cancel any calibration error causing an inability for the vehicle to hover in a single location. For example, if the vehicle drifts to the right when the vehicle attempts a hover maneuver, then the vehicle drifts right for t seconds, turns 180 degrees, and drifts toward what is now left for t seconds, thus canceling out the drift.

In one embodiment, the vehicle is an aircraft and the fluid medium is air. The vehicle can be used to measure wind velocity in a plurality of locations within a volume of air, thus creating a “wind map” of an area at one or more altitudes.

In another embodiment, the vehicle is an aircraft and the fluid medium is air. The vehicle can be used to generate a wind map about a plurality of locations selected to be of decision-making utility. For example, the wind map could be utilized by a sailboat crew and the plurality of locations could comprise points along the sailboat's intended course. In another embodiment, the aircraft is configured to stay aloft for a continuous period of time, making repeated wind velocity measurements to expand or update the wind map as the boat moves, the wind shifts, and as tactical sailing objectives change.

In another embodiment, the vehicle's launch point and landing point can comprise one or more of a ship, a stationary land base, a ground vehicle, an aircraft, a submarine, a buoy, a water surface, and a ground surface.

In another embodiment, the vehicle is an aircraft and the fluid medium is air. The vehicle can be configured to make sample wind velocity measurements to identify wind gradients. Optionally, following the identification of wind gradients, the vehicle can be commanded through a directed search for locations with optimal wind characteristics. In one embodiment, optimal wind characteristics include those particularly well-suited for driving wind turbines. In another embodiment, the aircraft may search out locations having the greatest wind speeds at 100-200 feet altitude over a given region of land.

In another embodiment, the vehicle is an aircraft and the fluid medium is air. The vehicle can be used to generate a wind map that may be of interest to a building designer, wind turbine installer, or a high-rise construction crew. Such entities may use such wind maps to determine the optimal locations, or worst locations, for buildings, wind turbines, or high-rises. Additionally, the vehicle may be used to identify near real-time wind velocities near a jobsite where a construction crews may need to operate below a certain wind threshold, such as for example where cranes are being operated.

In another embodiment, the aircraft creates a wind map of locations selected for their utility in weather forecasting, or in modeling the dispersion of a substance (such as a pollutant, pollen, gas leak, etc.) via the air.

In another embodiment, the aircraft is directed to repeat wind velocity measurements over a period of time so as to monitor wind changes at one or more locations of interest.

In one embodiment, the vehicle is configured to calibrate itself within its fluid medium. One method of calibration may include commanding the vehicle to make predetermined maneuvers and measure the effect of those maneuvers on the vehicle's location and heading. For example, the vehicle may be directed to fly in a straight line, recording a series of locations along its path. If the path of the vehicle curves as indicated by the locations recorded by the location sensor, then the vehicle may be miscalibrated, requiring adjustment to the vehicle's rudder to achieve straight flight. The vehicle may identify a first location along its path using its location sensor. After the vehicle has traveled along its predetermined course (which will have a theoretical vector), it may identify a second location along its path. The second location and first location may be used to calculate an observed vector. Comparison of the observed vector and theoretical vector may yield some discrepancy. In the event that a discrepancy is identified, the vehicle's controller and control surfaces may be calibrated so that the observed vector is the same as the theoretical vector. In one embodiment, the vehicle's controller is programmed to perform this operation automatically. In another embodiment, the vehicle's controller is programmed to perform this operation at specific intervals to ensure the accuracy of its flight commands. In another example, the vehicle may be directed to travel in a 360 degree circle, wherein the duration of time required to complete the circle is noted and used to calibrate the vehicle. The vehicle may identify a first time at a first point along its path. After the vehicle has traveled along its predetermined course (which will have a predicted time), it may identify a second time at a second point. The first time may be subtracted from the second time to yield an actual time of performing the maneuver. Comparison of the actual time to the predicted time may yield some discrepancy. In the event that a discrepancy exists, the controller and the vehicle's control surfaces may be calibrated so that the actual time is equal to the predicted time. Such calibration methods can be performed and implemented either before the intended maneuvers (to help ensure accuracy), or after the intended maneuvers (to mathematically correct for predicted errors in the maneuvers).

In another embodiment, the vehicle is configured for a plurality of mission objectives, rather than the single objective of measuring wind velocity. For example, the vehicle may combine the wind-measurement process with other flight objectives. In one embodiment, the wind-measurement flight segments may be added to commands issued to an unmanned aircraft performing a GPS-guided or manually-guided visual reconnaissance flight. In another embodiment, wind-measurement flight segment may be added to various dispersal missions, such as crop-dusting.

In another embodiment, the vehicle is an aircraft and the fluid medium is air. The wind velocity measurement process may be used not to map winds, but rather to test, recalibrate, or backup the aircraft's onboard airspeed or fluid velocity sensors, such as pitot tubes. Such onboard airspeed sensors may fail or become miscalibrated as a result of icing or other weather issues. In another embodiment, the vehicle is a watercraft and the fluid medium is a liquid. The fluid velocity measurement process may be used to map currents, as well as to test, recalibrate, or backup the watercraft's onboard fluid velocity sensors.

In another embodiment, the vehicle is used to measure fluid velocities that affect other unmanned craft that may be unable to use controls to modify their courses in a fluid. For example, the unmanned craft may be a projectile, such as an artillery shell. In another example, the unmanned craft is a less sophisticated craft that needs to reach its destination correctly despite current fluid velocity conditions. In one embodiment, the vehicle used to measure fluid velocities communicates the fluid velocity to the second vehicle (e.g., another manned craft, unmanned craft, or projectile) such that the second vehicle may modify its heading in the fluid to account for the velocity. In another embodiment, the vehicle used to measure fluid velocities communicates the fluid velocity to the operator of the second vehicle (whether the operator is onboard the vehicle or offboard), such that the operator may modify the vehicle's heading in the fluid to account for the velocity.

In another embodiment, the vehicle uses a hybrid approach to measuring wind velocity. For example, the vehicle may be an aircraft configured to release a floating or slow-sinking substance into the air. Such substance may include chaff, dust, engine smoke, parachutes, or balloons. The aircraft may utilize the wind measurement methods recited herein, while using the released substance to supplement these methods.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. An apparatus for measuring a fluid velocity, comprising:
a vehicle;
a location sensor configured to identify a location of the vehicle at two or more points in the fluid; and
a controller configured to control a movement of the vehicle in the fluid,
wherein the controller is configured to calculate a vector using the two or more points in the fluid.

2. The apparatus of claim 1, wherein the vehicle is at least one of an airplane, a helicopter, a boat, and a submarine.

3. The apparatus of claim 1, wherein the vehicle is unmanned.

4. The apparatus of claim 1, wherein the location sensor is at least one of GPS, LORAN, a triangulation system, RADAR, and LIDAR.

5. The apparatus of claim 1, wherein the location sensor is located onboard the vehicle.

6. The apparatus of claim 1, wherein the controller comprises a computer having software.

7. The apparatus of claim 1, wherein the controller is located onboard the vehicle.

8. The apparatus of claim 1, wherein the fluid is at least one of air and water.

9. A method for measuring a fluid velocity, comprising:
placing a vehicle in a fluid;
identifying a first location of the vehicle in the fluid at a first time using a location sensor;
causing the vehicle to travel in the fluid along a predetermined course having a predicted end location using a controller;
identifying a second location of the vehicle in the fluid at a second time using the location sensor; and
calculating the fluid velocity by comparing the second location with the predicted end location.

10. The method of claim 9, wherein the vehicle is unmanned.

11. The method of claim 9, wherein the location sensor is at least one of GPS, LORAN, a triangulation system, RADAR, and LIDAR.

12. The method of claim 9, wherein the location sensor is located onboard the vehicle.

13. The method of claim 9, wherein the controller comprises a computer having software.

14. The method of claim 9, wherein the controller is located onboard the vehicle.

15. The method of claim 9, wherein the fluid is at least one of air and water.

16. The method of claim 9, wherein the predetermined course comprises at least one of a circle, an oval, a figure-eight, a series of circles, a series of ovals, a series of figure-eights, a straight line, and a series of straight lines.

17. The method of claim 9, wherein the predetermined course comprises one or more closed courses, wherein the use of a closed course results in a cancellation of at least one error in calculating the fluid velocity.

18. The method of claim 9, wherein the vehicle is an aircraft and the fluid medium is air.

19. The method of claim 18, further comprising calculating fluid velocity in various predetermined locations to create a two-dimensional or three-dimensional wind velocity map of a region.

20. The method of claim 18, further comprising using the fluid velocity to recalibrate or backup the aircraft's onboard airspeed sensors.

21. The method of claim 9, further comprising communicating the fluid velocity to an operator of a second vehicle such that the operator may modify the second vehicle's heading in the fluid.

22. An apparatus for measuring a fluid velocity, comprising:
a vehicle traveling in a fluid measurement zone of a fluid medium;
a location sensor configured to identify a first location at a first time and a second location at a second time for two or more headings;
a controller configured to cause the vehicle to travel in the fluid measurement zone at two or more headings, wherein the sum of the two or more headings is equal to zero;
a velocity vector defined by the first location of the vehicle at a first time, and the second location of the vehicle at a second time for each of the two or more headings; and
a fluid velocity vector defined by the addition of the velocity vector for each of the two or more headings.

23. The apparatus of claim 22, wherein the orientation of the two or more headings having a sum of zero results in eliminating at least one error in calculation of the fluid velocity vector.

24. The apparatus of claim 22, wherein the vehicle is an aircraft and the fluid medium is air.

25. The apparatus of claim 22, further comprising at least one additional fluid velocity vector calculated in additional locations in a region, wherein the at least one additional fluid velocity vector defines a two-dimensional or three-dimensional fluid velocity map of the region.

26. The apparatus of claim 22, wherein the vehicle further comprises onboard fluid velocity sensors, and wherein the onboard fluid velocity sensors are recalibrated or backed up using the fluid velocity vector.

27. A method for measuring a fluid velocity, comprising:
placing a vehicle in a fluid, wherein the vehicle is hover-capable;
identifying a first location of the vehicle in the fluid at a first time using a location sensor;
identifying a second location of the vehicle in the fluid at a second time using the location sensor; and
calculating the fluid velocity by comparing the first location with the second location.

28. The method of claim 27, further comprising causing the vehicle to hover facing a first direction for an amount of time and causing the vehicle to hover facing a second direction for an amount of time;
wherein the second direction is 180 degrees from the first direction; and
wherein causing the vehicle to hover facing the first direction for an amount of time and the second direction for an amount of time results in a cancellation of at least one error in calculating the fluid velocity.

29. A method for calibrating a vehicle's controller, comprising:
placing a vehicle in a fluid;
identifying a first location of the vehicle in the fluid at a first time using a location sensor;
causing the vehicle to travel in the fluid along a predetermined course having a predicted end location and a theoretical vector using the controller;
identifying a second location of the vehicle in the fluid at a second time using a location sensor and calculating an observed vector;
comparing the observed vector and the theoretical vector to identify any discrepancy between the observed vector and the theoretical vector; and
calibrating the controller and the vehicle's control surfaces so that the observed vector is the same as the theoretical vector.

30. The method of claim 29, further comprising:
subtracting the first time from the second time to calculate an actual time;
comparing the actual time to a predicted time for the vehicle to travel in the fluid along the predetermined course;
calibrating the controller and the vehicle's control surfaces so that the actual time is the same as the predicted time.
